(19) United States
(12) Patent Application Publication
(10) Pub. No.: US 2024/0009494 A1
(43) Pub. Date: Jan. 11, 2024

(54) Automatic Firefighting Gun equipped with a multifunctional flame detector

(71) Applicant: abdelali baida, Hassi el garra el menea w Ghardaia (DZ)

(72) Inventor: abdelali baida, Hassi el garra el menea w Ghardaia (DZ)

(73) Assignee: abdelali Baida, el menea w ghardaia (DZ)

(21) Appl. No.: 17/547,262

(22) PCT Filed: Apr. 15, 2020
(86) PCT No.: PCT/DZ2020/050005

§ 371 Date: Dec. 10, 2021

(30) Foreign Application Priority Data
Nov. 6, 2019 (DZ) DZ/P2019/000529

(51) Int. Cl. A62C 31/02; A62C 31/28

(52) U.S. Cl. CPC A62C 31/02; A62C 31/28

(57) ABSTRACT

The present invention is a an automatic firefighting gun fitted with a multifunction flame detector, it is designed primarily for use in airstrips and in general in all areas of safety, prevention and control, it can be used automatically or directly by any peasant, trader or surveillance agent, in addition he is easy to use even by a single disabled person, and its installation is also simple as its maintenance, it consists of many main accessories and others that are secondary, it is installed according to the place in danger, it can be installed in many positions, moving, stationary, alone, in series, attached to the reverse or in a helium balloon, or in a special helicopter, we can even install it with any logical control system, we install and connects it with special hose of water, foam, salt powder, fire gas or fresh air, it is used with special accessories depending on the area concerned by fire either in aircraft runways or in sensitive buildings threatened damage or accidents, in addition it can be installed anywhere near the homes or inside, in the tunnels, in the train station, in public squares, in warehouses, in the forests and farms all this is for the purpose of preserving life, proprieties and public security.

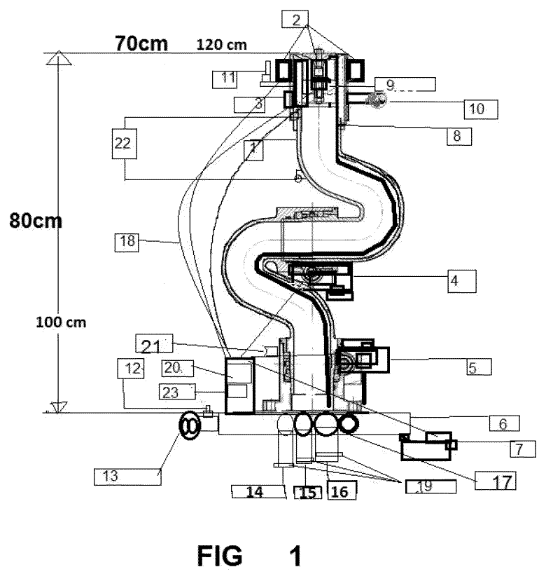

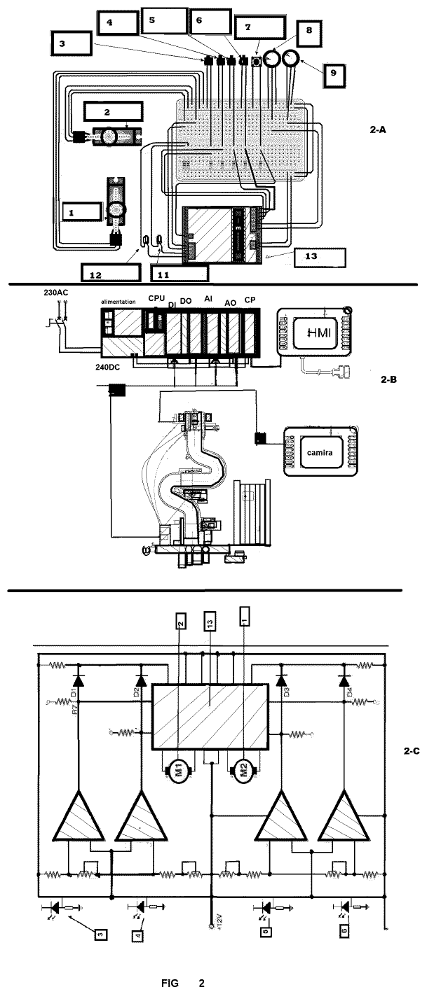

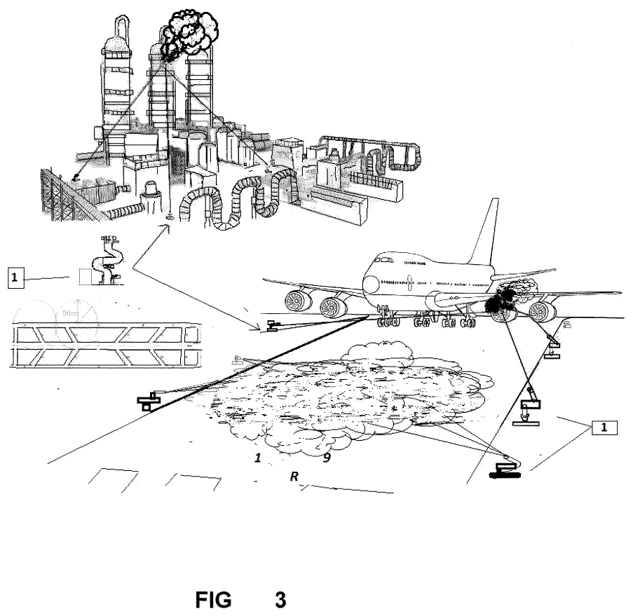

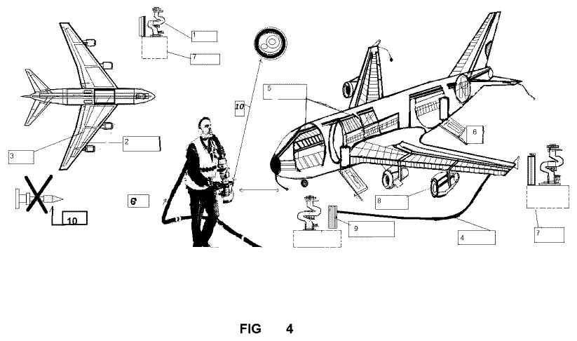

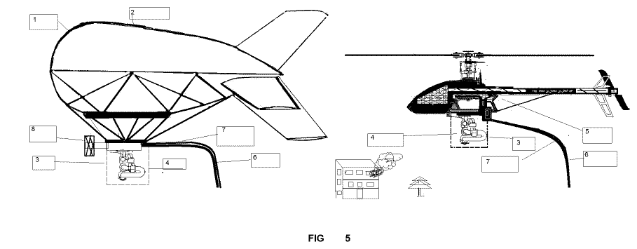

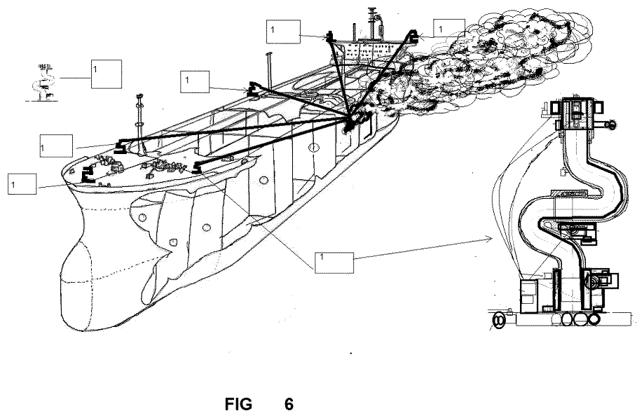

### THE INTRODUCTION

This invention provides an essential service for public safety, industrial, personal and general use, the preservation of properties and the personal security, it aims to help firefighters quickly and effectively in fighting fire in case of explosion and asphyxia, it prevents the spread of fire without combining a great effort, it is dedicated to protection and safety, and it is ensured that it works efficiently and over a long period of time, in addition to replacing all firefighter equipment, this device also provides a great service for HSE in general and for all zones and delicate natural conditions and for all sensitive buildings such as ship, airstrip and combustible, explosive stations, these zones are subject to the spread of toxic gases or lack of ventilation which is is a real danger for people and the zone of risk where we forbid working on it, all that is thanks to an invention of automatic fire gun device fitted to a multifunction flame detector. In fact many inventors and companies of prevention and safety competition of creating an effective protective invention equipment and works in any locations, in natural and industrial conditions and also preserve properties with a low cost knowing that the this invention works everywhere in any place, at all times and continuously thanks to a central power supply resource in addition that it can not be affected by the climatic condition like sandstorm, ice, temperature rise or industrial factors such as explosion, damage, gas propagation or lack of ventilation it works with automatic control system or remote controlled system using special applications in the public or in large buildings, it is only one person who makes the order.

Thus this device is connected into the various areas of protection, safety and industrial security, to have an early alarm, vigilance, and artificial intelligence, this ensures an effective intervention and it can be used in any risk and condition.

The technical side of invention: The invention related to the field of HSE, industrial safety and fire fighting, early warning alarm and multifunctional intervention, this is an automatic firefighting gun fitted whit a multifunctional flame detector that allows us to detect the flame location in any position, it can replace an indoor or outdoor firefighting system anywhere and at any time available anywhere with multiple size and shapes, it can even be connected to another device.

The Old Industrial Technique:

At present several firefighting equipment are used such as fire truck, manual tools, and aircraft the traditional tools requires a great physical effort and there is a risk in some sites such as forests, factories, airplanes, tunnels and terminals, in this case the role of firefighters is paramount, limited, and they are in risk, in furthermore they raise the risk of burning, lack of aeration, lack of water, to be surrounded by fire and by the result there is an potential death that is because there are some inefficient equipment used in the old technique in HSE and airports, also trucks of special firefighters who require great training and an exhaustive effort is also required to fix it with the guaranty of safety intervention device, after securing the runway and a strict order from control tower for an extinguishing operation of the aircraft is only done after the consultation of control tour and follow instructions and orders given for the rescue team following runways precise on the tarmac, they pour foam into the airstrip, this operation takes more half an hour on landing and flight so the airport will be out of service, thus is old technique is complicated, not efficient in a plant or oil platform, these techniques do not use it after closing all gas or oil valves to secure the firefighters of a likely gas leak that would cause an explosion

Also there is another ancient technique of extinguishing an aircraft from the inside per arm equipped with a large steel pike that penetrates the body of the plane, because of this technique the extinction of the plane will be carried out in hazard which damages the sensitive and expensive devices inside it, thus the aircraft will be out of service so it is not feasible, there is the stationary extinguishing gun fitted with the truck the form 4 n10 with a manual or electrical control system but it is not feasible in case of accidents mobile such as aircraft firefighting on a runway with a defined and high-speed author or in a place where no one can reach it with this truck, so in this area we use manual CO2 extinguishers, with a good functioning.

Robots have a limited and precise role, they can be operated only by trained firefighters in these operations in addition it takes a long of time to be fixed. Its tanks have limited capacity, it is not available for everyone and its ire base is not accurate. All the old techniques have disadvantages besides effort and a waste of time and

A registered delay in the intervention is also not feasible and effective.

This invention will work better and with good accuracy and efficiency to protect personal properties and the environment because it works differently.

### PURPOSE OF THE INVENTION

It aims to introduce a new and effective fire-fighting, rescue and personal and industrial safety what could increase the risk of asphyxiation, explosion or fire, it works via artificial intelligence in public places and it is role is not just intervene but to protect the properties of others.

It works continuously detecting the flame base whether by stationary or spatially moving. it alarms in the presence of the fire and asphyxia via an SMS, photos, and videos sent to predetermined sites for firefighters or ambulance, family members or storekeepers It shuts down the electricity depending on the location of the fire, apart from its power cable.

It draws gas and pumps cleaning air with remote control system, automatically or Bluetooth, but in large buildings and industrial sites it is controlled via a special control room and works several days without stopping.

It can replace firefighters and operate in risk and open sites, it is installed in several positions either horizontal, vertical, inclined, hung or inside in tanks,

there more it can be used anywhere in the world, in the ovens, in airport and feasible for everyone and in sensitive places, it also helps firefighters in their effective response and extinguish several fires at the same time such as fire of several aircraft on the same runway, it works fast without delay as it is indicated in the form 3, contrary to the old technique where firefighters cannot intervene unless after the aircraft's speed decrease and the postponement of several take-off operations, and our invention deals with incidents that occur at the same time and place on a runway, whether by incidence or a delicate release incident and without combining any effort by firefighting team, only one firefighter person can determine the fire base and open firefighting liquid tap, in same time a pump operates automatically via driver which press in a button without the use of a firefighting team, it can be used in pump stations and public places where lighting a cigarette or making a fire is prohibited, because it designate the person directly by a laser light or towards the source of fire and take a photo at the same time, it allows to protect the properties of people like shops, libraries and factories as it only targets the flame base and does not damage the next door, bodies that are away from fire because it is configured carefully it plays the role of a surveillance officer and a firefighter, it give an early warning alarm and controls all sites such as the airstrip, oil tankers, gas carriers and sensitive public places that are threatened by fire and damage because the device is equipped with a detector technology flame and it allows to do many operations and detect the flame whether it is mobile or immobile space while recording a video to determine the cause of the fire in first moments, as it also replaces firefighters in dangerous places as it is intended to personal use, it is also fitted with automatic, special accessories, as it is indicated in the Form 3, it replaces the firefighting trucks in the airstrip, it sprinkle special aircraft foam while landing and salt to remove ice from the runway in few seconds and extinguishes an aircraft whether inside or out of it also it performs an official reception by forming an arc along the aircraft runway, where several operations are carried in short time without using trucks with that can extinguish an aircraft abroad without breaking or penetrating the body of the aircraft or damaging aircraft and this is carried out by using hoses that distribute carefully on all parties and with the suitable extinguishing agent as it is indicated in Form 4, also extinguishing giant gas tanks in interior which is a real risk, but with a great precision without the intervention of firefighters, without risk, the device can be fitted with a helium balloon to perform an intervention in a skyscraper or high towers and it records videos and photos and does many operations depending on the personal orders.

### LIST OF FORMS

Form N 1 a automatic fire gun fitted with a multifunction flame detector
1 The Fire Gun Shape and Main hose.
2—A flame detectors with 10 up to 90 m flame detection depending on the work site
3—One motor to raise and lower
4—An engine to aim in both directions left and right.
5—A firefighting gun base that can be installed in several positions.
6—An engine to bring out and enter the firefighting gun head in a turtle technique to protect it against a potential collision with a moving body such as the glide of an aircraft
8—A special hose for CO2 at the same time, it can be used to sprinkle fresh air, other gas or air for special purposes
9—a flashlight fitted with a laser pen
10—An alarming lamp that works with special signal lamps for tarmac and factories.
11—A camera that works night and day.
12—An electric and manual valves.
13—A special double-outlet hose connection for the internal extinguishing of aircraft bodies and of ships.
14—A special inlet hose for extinguishing gas, air or other gas.
15—A special hose entrance for the firefighting foam.
16—One hoses Inlet for water
17—An inlet for melting ice by special salt.
19—An electric valve to determine the agent should be used whether, gas or liquid.
20—The unit or processor panels of each firefighting gun depending on the work site.
21—A multifunction device holder such as a motion detector or test and analysis device of gas in the environment.
22—a holder for any jamming tool against a drone or combat a projectile.
23 A special unit to control everywhere.

Form N 2, A diagram showing how to install an automatic firefighting gun fitted with multifunction flame detector technically designed for personal use.
1—A twin rotation stepper motor.
2—A twin rotation stepper motor.
3.4.5.6 of flame detectors
No 1; turn the firefighting gun left or right.
N2 Raise and lower the firefighting gun head.
N3: It is installed left.
N4: It is installed on the right
N5: It swivels to the left
N6: It is installed below to the right
N7—The position button change.
N8—To control the movement from top to bottom.
N9—to control movement from left to right.
N10—For the manual position.
N 11—for automatic position
Form 03: a automatic firefighting gun fitted with a multifunction flame detector, it is used in industrial safety such as factories and airstrips.
The form 04—a automatic firefighting gun fitted with a multifunction flame detector installed in any body as in the aircraft for doing interior extinction
1—a automatic firefighting gun fitted with a multifunction flame detector.
2—a foam cannon for fuel gas tanks.
3—one hose for extinguishing agent or extinguishing gas for eclectic sensitive devices and they have special purposes.
4—The double outlet hose connected with the fire truck and the aircraft.
5—Classes to distinguish and determine only the fire site.
6—double outlet hose move out in firefighter ladder at the same time in many places on the plane.
7—An underground box contains the device in case of shutdown.
8—hose complexity in engines
9—Hose holder with double outlet beside firefighting gun.
form 5—an automatic firefighting gun fitted with a multifunction flame detector, it is connected on a balloon of helium, or on an electric helicopter powered by a special hose as it indicated in form 5
1—A helium gas balloon
2—the helium gas
3—pivot base and firefighting gun cover.
4—an automatic firefighting gun fitted with a multifunction flame detector
5—a special helicopter
6—A special hose for Gas product or extinguishing liquid.
7—wires for taking of photos and provide a map for control operation.
8—an engine to guide the balloon in all directions
Form 6: installation technique in ships, tankers and platforms in general

The exhibition of the contents of this invention and how it works:

This invention is a automatic firefighting gun fitted with a multifunction flame detector that consists four flame detectors and one temperature detector and other accessories depending on the site also a HMI control screen and another screen to expose and broadcast live photos to control the extinguishing operation, also using a joystick to control any firefighting gun designated, by stopping automatic switch off service in industrial security in addition to a laser pen, flashlight, alarm lamp, extension cables, central pumps and secondary liquids of water, fire foam, salt powder and three engines in certain cases, fitted with a camera that works in the night and day with OPENCV technique special hose of water, foam hose, special salt product, fresh air, or any gas, equipped with a four-position nozzle and electric valves;
the functions of these components are as follows:
temperature sensor consists of four flame detectors to determine the flame location and provide a warning fire alarm, they are installed in the nozzle of the device distribute in the four directions their role is to detect the flame from far away and at the moment and move horizontal and vertical and determine the real flame location, when flame is detected at the same time a signal will be sent to the third engine to put the nozzle in service And a temperature sensor nearby to measure the amount of heat energy or even coldness that is generated by this device or another device.
installation cables to conduct signals and electricity between all the device components with the control panel or to any electronic panel, or operator SCADA D PLC/HMI system

If there is many devices it depending on usage such as airports, gas station and sites in risk of damage, this device will be connected with other devices in series and parallel to the logical control systems of industrial security and other to special Arduino operators, it also connected with a PLC panel like the special code of programming for proper operation and apply it with all its components for regulate its movements and organize is fitted by a Bluetooth panel board or a remote control panel, an alarm lamp to make a signal when the device is operating and a flashlight it is designed to be used day and night with a small laser lamp used in case of fog and provide an alarm warning in public places where it is forbidden to smoke or lighting fire and step engines for a precise and fast orientation, they are two motors one to move the device from right to left with an angle of 360 degrees, it stops and then moves to the other side to protect the cables and the second motor to raise and lower the nozzle of the device in the angle of 290 degrees for a cover it in a dome shape of a perimeter of 65M, the perimeter can be extended according to the quality of detector.

In some cases a fourth motor to lift the device via a special track from its base out of its box because its head is in constant or immobile underground so it is not an obstacle on the ground unless after detecting flame or receiving of an order to make an intervention a special door will be open, where fourth engine have a great role it lift device 0.5 meter from the earth surface when an aircraft glide or is in complete standstill where the movement detectors plays an important role in lifting it to 1.5 meter protecting the device from a potential collision with another body such as a car, truck, plane or any other device used in airport runways with a base of the device installed it in many positions and an electric valve, a double manual valve with a dual hose to connect it with another pipe coming out from the the emergency ladder and to connect it with the aircraft body from the inside, it allows to turn off each part of aircraft apart with any precision and the control system differs depending on place we operate, if you are in a plant or airport, the main control device will be a fixed chair in the control tower to provide global control with special screens in the purpose to broadcast live photos via an HMI screen with SCADA system and that is thanks to many cameras connected in each head, there is another secondary device which is a Bluetooth remote controller from limited distance for monitoring fire location and regulate some special cases signaled by control room, this is optional.

The technique of execution of intervention: it is a double hose input unit composed of four input in the four directions connected to PLC to the output unit that is four output one engine for each two to control the direction of engine rotation and guide the device to the goal accurately.

```
Coude
#include <Servo.h>
//Initialize variables
int mode = 0;
intbuttonState = 0;
intprevButtonState = 0;
inttopLeftFlame = 0;
inttopRightFlame = 0;
intbottomLeftFlame = 0;
intbottomRightFlame = 0;
intLeftFlame = 0;
intRightFlame = 0;
intTopFlame = 0;
intBottom Flame = 0;
//Declare two servos
Servo servo_9;
Servo servo_10;
voidsetup( )
{
pinMode(7, INPUT); //Mode Button
pinMode(12, OUTPUT); //Led indicator for manual mode
pinMode(11, OUTPUT); //Led indicator for auto mode
pinMode(A0, INPUT); //Potentiometer for right-left movement
pinMode(A1, INPUT); //Potentiometer for up-down movement
pinMode(A2, INPUT); //Flame sensor up - left
pinMode(A3, INPUT); //Flame sensor up - right
pinMode(A4, INPUT); //Flame sensor bottom - left
pinMode(A5, INPUT); //Flame sensor bottom - right
  servo_9.attach(9); //Servo motor right - left movement
  servo_10.attach(10); //Servo motor up - down movement
}
voidloop( )
{
buttonState = digitalRead(7);
if (buttonState != prevButtonState) {
if (buttonState == HIGH) {
    //Change mode and Flame up the correct indicator
if (mode == 1) {
mode = 0;
digitalWrite(12, HIGH);
digitalWrite(11, LOW);
    } else {
mode = 1;
digitalWrite(11, HIGH);
digitalWrite(12, LOW);
}
  }
  }
prevButtonState = buttonState;
delay(50); // Wait for 50 millisecond(s)
if (mode == 0) {
  //If mode is manual map the pot values to degrees of rotation
  servo_9.write(map(analogRead(A0), 0, 1023, 0, 180));
  servo_10.write(map(analogRead(A1), 0, 1023, 0, 180));
  } else {
  //if mode is auto map the sensor values to 0-100 Flame intensity.
  //Every light sensor has different sensitivity and must be first tested
  //for it's high and low values
topLeftFlame = map(analogRead(A2),50,980,0,100);
topRightFlame = map(analogRead(A3),200,990,0,100);
bottomLeftFlame = map(analogRead(A4),170,970,0,100);
bottomRightFlame = map(analogRead(A5),250,1000,0,100);
  //Calculate the average Flame conditions
TopFlame = ((topRightFlame + topLeftFlame) / 2);
BottomFlame = ((bottomRightFlame + bottomLeftFlame) / 2);
LeftFlame = ((topLeftFlame + bottomLeftFlame) / 2);
RightFlame = ((topRightFlame + bottomRightFlame) / 2);
  //Rotate the servos if needed
if (abs((RightFlame − LeftFlame)) > 4) { //Change position only if Flame difference is bigger then 4%
if (RightFlame<LeftFlame) {
if (servo_9.read( ) < 180) {
servo_9.write((servo_9.read( ) + 1));
    }
    }
if (RightFlame>LeftFlame) {
if (servo_9.read( ) > 0) {
servo_9.write((servo_9.read( ) − 1));
    }
    }
  }
if (abs((TopFlame − BottomFlame)) > 4) { //Change position only if Flame difference is bigger then 4%
if (TopFlame<BottomFlame) {
if (servo_10.read( ) < 180) {
servo_10.write((servo_10.read( ) − 1));
    }
    }
if (TopFlame>BottomFlame) {
if (servo_10.read( ) > 0) {
servo_10.write((servo_10.read( ) + 1));
    }
    }
  }
```

1. an automatic firefighting gun fitted with a multifunction flame detector, it is an effective and developed tool it is used in the field of industrial safety and protection, the safety and early fire warning alarm system and it works with automatic firefighting gun fitted with a multifunction flame detector, it can replace or substitute any protection system in all sites and buildings constructions, it can be controlled by many devices such as a remote control, a direct control or automatic that work with personal use or public.

2. an automatic firefighting gun fitted with a multifunction flame detector with a protection system, whose main element is firefighting gun which consists of four main flame detectors they can be placed in the four directions, they detect at a great distance and secondary motion detectors can be installed or added depending on the location where we use.

3- an automatic firefighting gun fitted with a multifunction flame detector equipped with dual rotation engine to horizontal or vertical rotation another for controlling the nozzle and in some case fourth engine used to lift and taking down the device in operation.

4. Fire Gun self-guided equipped with a multifunctional flame detector and protection element, it is designed to guide its nozzle without using any flame detector it works with optic detection technique (OPENCV), and via a programming code designed to specify and locate moile flame where we use electro optic system to flame base, it allows also to measure the distance between device and flame base in order to rise pumping power and that is depends on the required distance, we should alert all fire gun in use in order to put out fire at the same time we can use it in runway, stockrooms, and harbor as it indicated in form (3 and 6)
Code
: Raspberry Pi setup +Opencv Isntallation on Raspberry Pi
#### 2. Moving Motors
################################
### Vertical
if cy!=0:
centerY = frameHeight//2
if cy>centerY+20:
posY = int(np.clip(posY+10,1400,2000))
elif cy<centerY−20:
posY = int(np.clip(posY−10,1400,2000))
pi.set_servo_pulsewidth(servoPinVer,posY)
#### Horizontal
if cx!=0:
posX = int(conRange(frameWidth,0,1100,1700,cx))
pi.set_servo_pulsewidth(servoPinHor,posX)
# cv2.imshow(“Mask”, mask)
# cv2.imshow(“ColorResult”, result)
# cv2.imshow(“Canny”,imgCanny)
cv2.imshow(‘Result’, imgContour)
if cv2.waitKey(1) & 0xFF == ord(‘q’):
break
.....

5- an automatic firefighting gun fitted with a multifunction flame detector with a protection system connected to a camera that works night and day.

6- an automatic firefighting gun fitted with a multifunction flame detector with a protection system, equipped with an installation and extension cable between the motors and the electronic panels and the detectors to enter the data sent by the detectors through the direct control.

7- an automatic firefighting gun fitted with a multifunction flame detector with a protection system equipped with special water salt and foam hoses, and another hose for pumping fresh air or pumping gas or any chemical agent to dissipate fog which may cause aircraft accidents in runway.

8- an automatic firefighting gun fitted with a multifunction flame detector with a protection system, equipped with an alarm lamp and another for sufficient ignition and alarm during intervention.

9- Fire Gun self-guided equipped with a multifunctional flame detector and protection element, it works without using flame detector in direction, it sets the pump power to suck up tank thanks to very powerful pumping, while measuring off distance electronic domestic and firefighting nozzle for furniture and water or any other liquid

10- an automatic firefighting gun fitted with a multifunction flame detector with a protection system equipped with electronic valves to facilitate the selection of extinguishing agent to be used and to connect it with any fire system or gas cylinders.

11- an automatic firefighting gun fitted with a multifunction flame detector with a protection system equipped with a special double hose that connects between the device and other connection, it is installed on the body of aircraft inside to connect it with a special fire fighting center is located in the aircraft to extinguish fires and protect other aircraft from fire.

12- an automatic firefighting gun fitted with a multifunction flame detector according to protection system equipped with the base device which is installed in several positions horizontal, vertical or in reverse with all stationary or spatially mobile positions.

13- an automatic firefighting gun fitted with a multifunction flame detector depending on the protection system to carry out aerial firefighting by a device installed on a helium balloon or on a special helicopter for altitudes and this is by putting it in a holder in a ground based motionless or mobile such as a control room to ensure the control operation of the balloon by lifting, taking down or guiding it in all directions and power it it with energy also pumping extinguishing agent in the purpose of controlling fire as it indicated in shape.

14- an automatic firefighting gun fitted with a multifunction flame detector according to protection system which is connected with a protection and prevention system used in run aircraft runways, houses and shops with a broadcast of a video of photos and direct control of any place.

15- an automatic firefighting gun fitted with a multifunction flame detector depending on the programming codes to coordinate the functions of the devices and to precise and accurate automatic movements.

16- an automatic firefighting gun fitted with a multifunction flame detector with a protection system, equipped with many devices installed in parallel or in series on aircraft runway in order to perform many movement for the reception of known persons, Presidents or kings, where we form bows of water while the plane passes on the runway or any mosaic shape.

17- an automatic firefighting gun fitted with a multifunction flame detector according to t protection system has special safety purposes such as pumping anesthetic gas to release hostages in a special operation there more helping firefighters in their intervention safely and accurately.

18- Fire Gun self-guided equipped with a multifunctional flame detector and protection element designed to protect fireman against explosion or gas asphyxia during working, thanks to this device we can even work without firefighter, especially in risky site, commanding and remote controlling it automatically, it is applicable in factories that are subject to toxic products, leaking or lack of air, this device works thanks to gas detector installed on it to warm and pump a sufficient air near to it to protect workers in risky places.

19- an automatic firefighting gun fitted with a multifunction flame detector according protection system, it is designed to operate in the smart cities and artificial intelligence.

20- an automatic firefighting gun fitted with a multifunction flame detector according to protection system equipped with a self-guided head fitted with four flame detectors that detect the flame in the four directions thus, one turns the nozzle towards the flame base or to tracking.

21- an automatic firefighting gun fitted with a multifunction flame detector depending on protection system any accident happens on the runway or in an industrial site one person will intervene whether by control room, control tower or by remote control device which works with Bluetooth and for the public use we control by a mobile phone or a board panel from any location and for home use.

22- an automatic firefighting gun fitted with a multifunction flame detector depending on protection system, extinguishing the interior of an aircraft using special double-outlet hose, one side is installed in the device and the other in a specific points in the aircraft body by any one of the aircraft crew without endangering any electrical material a board it.

23- an automatic firefighting gun fitted with a multifunction flame detector according to protection system it is developed to protect all sensitive devices on board of the aircraft it works just in areas affected by the fire and it does not damage other equipment a board, in addition its role is to protect all interior components and this is done through special hoses connected with device as it is indicated in form N . . . to sprinkle special foam just on engines, tanks and wheels but for the powder it is also sprinkled into sensitive devices such as microcomputers and counter, etc.

24- an automatic firefighting gun fitted with a multifunction flame detector according to protection system, we sprinkle a special foam of gliding planes in case of landing at the length track within a maximum of 3 minutes with the possibility of identifying one side of the other, all this is done by a one person pressing button from a control room.

25 an automatic firefighting gun fitted with a multifunction flame detector according to the protection system, it sprinkle a special salt powder for icebreaking and snow on the runway of the aircraft within 5 Mn for cold regions where firefighters cannot accomplish their mission because of violent ice storms or freezing cold.

26- an automatic firefighting gun fitted with a multifunction flame detector depending on protection system with a motion detector that protects its body from a potential collision with a other bodies such as aircraft in glide or a truck within a safety distance of 10M, the firefighting gun stops then automatically returns to its ground base.

27- an automatic firefighting gun fitted with a multifunction flame detector according to the protection system it lift 2 m height off the surface of the ground to avoid hitting the passengers when they escape from the aircraft during fire.

28- an automatic firefighting gun fitted with a multifunction flame detector depending on the protection system, it is considered as a documentation tool and source of data that give evidence for all accidents.

29- Fire Gun self-guided equipped with a multifunctional flame detector and protection element it is considerate as an effective tool and method in intelligent towns because firefighters can run it from any place, wherever they are without moving from, so we avoid traffic thanks to special device that send an urgent alarm to local administration or special organization because every device is defined by a number, address and number of network for produce photo in live and all that a whatever the condition we can call fireman to alarm about fire

30- an automatic firefighting gun fitted with a multifunction flame detector according to the protection system, an electric detonator tool is installed to spray electrified water on any designated person who opens fire with a gun in a mosque or in a university, the electric detonator is controlled by a special and secret button.

31- an automatic firefighting gun fitted with a multifunction flame detector depending on protection system, it is also used to spray special anesthetic spray on anyone poses a threat to himself or to the others.

32- It is used to rescue trapped person in high building by the means of lifting device as it is indicated in (5 form) via an electronic lever equipped with special pulley for lifting, for landing, rescueing a trapped persons that is applied by a rope for secure an organized landing

33- an automatic firefighting gun fitted with a multifunction flame detector according to role of firefighters and surveillance officers, it also provides video documentation.

34- Fire Gun self-guided equipped with a multifunctional flame detector and protection element is used to protect its component from anything near to it, it a alarm by optic sign and vocal message to avoid working accident in case of truck running in back or parking case in the edge of runway also to avoid collision slippery like airplane accident in case its wheel do not get out in landing, in a place subject of air pollution or toxication or chemical stations.

35- Fire Gun self-guided equipped with a multifunctional flame detector and protection element it records in prior a specific movement like watering airplanes with water (Water sautés water jumps), it is fixed between many gun fire in the edge of runways and between any gunfire 30 meters as it known in international level in air line reception and airplane flight for the first time, airplane are used to celebrate an old pilote retirement in the first or the last flight of an aircraft or for submerging runway during landing where the is a special foam.
for sliding in the duration of less than 5 Mn, whatever the length of the track, in all weather, then it is cleaned directly after the sliding operation in a lapse of time, also we clean snow, dust, or any obs tackle on the track

36- Fire Gun self-guided equipped with a multifunctional flame detector and protection element it runs without using a flame detector, it protect it, we use it as a support for jamming device or falling aircraft, it is put in small drones and destroy it also we use it in public spaces, building or in case of stealing goods

37- Fire Gun self-guided equipped with a multifunctional flame detector and protection element it is a protection tool for determined places that are subject to sabotage and aims at a space projectile in fire in a car park, a petrochemical factories, in a defined place or by using another tool like 15 short drone that has a fire product in order to destroy a place or burn it, for fight it, it depends on special camera for record a speed changements that happens it a defined zone b using encryption program code (OPENCV) which aims at direct and rapidly towards centre and base of mobile and fixed flame base

38- an automatic firefighting gun fitted with a multifunction flame detector according to the protection system, to determine which extinguishing agent we need

39- an automatic firefighting gun fitted with a multifunction flame detector according to the protection system, it has an application for special use, a limited use and civil use for public properties such as taking photos and videos, on its operation and provide alarm warning via the internet.

40- a self-guided fire gun to a multifunction flame detector according to the protection system to facilitate the control of PLC/Scada system via HMI screen designated for controlling the industrial security, in addition to another screen that broadcasts photos in live of any device during fire scene.

41- a an automatic firefighting gun fitted with a multifunction flame detector according to the protection system for civil use, it sends alarm warning messages depending of choice of people identified while registering their number, email address or even a number emergency of the competent authorities.

42- an automatic firefighting gun fitted with a multifunction flame detector depending on the protection system, the turtle head technique whit four motion detectors for a limited distance its role is to hide the cannon in a underground to protect it from a collision with another other object.

43- an automatic firefighting gun fitted with a multifunction flame detector according to the protection system, pressure meters that measures the pressure that identify the power and number of pumps which must be used automatically.

44- an automatic firefighting gun fitted with a multifunction flame detector according to the component protection, equipped with main joystick used in industrial safety.

45- a self-guided fire cannon with a multifunction flame detector with a Protection element has many option related to artistic and technique utilization
A—Direct command via control panel, lever, or a remote control done by an expert agent
B—Indirect command recorded in device memory as movements determined direction in prior, specify rule and time for run it by special code it can be runned by any person for carrying out a special mission, what we do from rotation angle from right to left, height, measure angle or any valve can be opened also pumpage powers that is to say, it affords many commands, at can also float a runway with foam and cooling air by aerosol.
C—automatic command is produced by this device without man intervention by this device of artificial intelligence in condition of carrying on this option, like alerting about fire and extinguish with being operated or commanded by a person, it ha also another options and utilization like cleaning of building glass and painting a high building (form 5,3) it is used to detect and do research at the sea and desert via a night or diurnal binoculars that specify a place is subjected to temperature change or has a high temperature, that is carried out by installing it inside a vessel, car, firefighter truck Submarine or another tools indicated in (form 5)

46- an automatic firefighting gun fitted with a multifunction flame detector depending on the protection system, it measures the gas level in its vicinity in in the field of industrial safety each device has a specific measurement.

47- an automatic firefighting gun fitted with a multifunction flame detector according to the protection system, when it detects a flame, it provides an alarm warning for the other devices thereby in its proximity or in front of the runway.

48- Fire Gun self-guided equipped with a multifunctional flame detector and protection element it is installed in all the rooms, complexes, and big store
All sort stadium, it treat and deal with any kind of stadium, in deal with riots in stadium, fire fire happens in supporters, stand, rooms, car it is installed up the stand to do a documentation and fire extinction, explosion occurring in stadium, or disperse supporters deal with sabotage.

49- an automatic firefighting gun fitted with a multifunction flame detector according to the protection system during the special foam sprinkling over the stadium stand where all firefighting guns are installed in parallel or in series directed to the right side of runway in 10 degrees at the left corner of 170 degrees in the four level from firefighting guns and with a high pumping power increasing depending each level, it allows using special oxygen tanks against fire.
It has the advantage of as being close to the location in risk and the person who commands is in far away and secure place.
It also works at any time and places, also in any delicate natural conditions.
It is can be programmed so it executes any complicated and delicate task for the human.

50- an automatic firefighting gun fitted with a multifunction flame detector according to the protection system the setting of operation time, and processing with any detector signal, in less than one second or in few seconds depending on the regulated time in prior.

51- an automatic firefighting gun fitted with a multifunction flame detector according to the protection system, it is available in several volumes depending on the use.

52 an automatic firefighting gun fitted with a multifunction flame detector according to the protection system, its purpose is to refresh air or cool it by sprinkling water like a spray as in big camps where temperature rise.

53- an automatic firefighting gun fitted with a multifunction flame detectoruim according to the component protection by means of Open CV library the liquid that comes out to the force of water does not hit any be alive as a man who flees from a burning plane because it is designed to change height unless the person is affected by the fire.

54- Fire Gun self-guided equipped with a multifunctional flame detector and protection element it is equipped with
A—projectile for special net throwing, and intervene I suicide case
B—We pour a special foam in runway, the gun fire must be installed in parallel and sequential in runways direction which is designed to perform applications of 10 degree in right angle in 170 in 4 levels left angle in the level of first hemisphere; second, third and fourth gun and another pumping power depending on the level for carry on an equal protection in all runways
E—It is distinguished by using of oxygen bottle in extinction that is carried out by installing in it a valve
F—It is placed near to risky zone also person is far from in a secure place installed in zone subject to fire or explosion
G—It runs wherever and whenever
H—we can program it to carry on a complicated task.
I—It is available in many volume a according to place utilization, it is installed also in rooms, park, stables, airplanes, cars and in small volumes in movement rooms, big volume, big factory and oil tankers (form 6), it aims to cooling atmosphere, cool down and watering parks
J—in case of temperature and some hot towns that are got almost all the year, season, in the forest also during dryness season for avoid a catastrophe like fire, avoid dust and sterilization of towns that are subject to virus propagation
K—By library (OPENCV) it is programmed for avoiding collision between and living being powerfully, or person escaping from airplane in fire it is set to change its altitude if this person is burned
L—Double fire hose it is special accessory used in runways it is considered as umbilical cord that feed airplane with extinction products inside it is connected to a special outlet in fuselage and that carrying out directly after get out of secure scale many hose get out of wing in forwards and back of airplane for facilitate joining operation by any steward or any person of crew as it indicated in form 4 N4, equipped with complicated net in inside it, with special method depending on the place and quality of necessary product of firefighting as indicate part 5-2 form 4 for simplified and insure fire extinction with a method that protect passengers and all sensible component of airplane that are inside without using (spear firefighters engine) using fire throwing that is equipped by automatic arm or the firefighters truck in order to penetrate fuselage and protect extinction product inside without caring about consequence of using this type

55- an automatic firefighting gun fitted with a multifunction flame detector
It sterilizes buses and airplanes from inside and outside, returning from the place of any virus or serious disease Without risking any medical team With the possibility of spraying it by the device anywhere it is available on the device and even identifying the person who is infected with any virus such as CORONA or SARS or, with a rise in temperature some adding a temperature sensor to the device in the four directions
a an automatic firefighting gun fitted with a multifunction flame detector depending on the protection system it can be used in the security field such as the freeing of hostages, by pumping an anesthetic gas towards the identified person inside an aircraft, in a building or ship, in addition it is easy to install, even disabled people or wheelchair users can use it.
It is easy to install with any firefighting system and control system in an automatic operation.
A special chemical liquid is pumped to clear the fog in runway aircraft.
It also allows transmitting all optical warning signals used in the the aircraft.
it forms lines by the laser lamp at along the plane runway.
it offers the possibility to cut electricity partially on any building construction on fire.
it has the advantage of having a variety of shapes with special measures depending on the use.
gas can be turned off in any place on fire or threatened with a leakage of gas therefore it pumping fresh air using special helicopters and through a hose located in the nozzle of device in the same it can vacuum any other sort of gas.
